(19) United States
(12) Patent Application Publication
(10) Pub. No.: US 2006/0121242 A1
(43) Pub. Date: Jun. 8, 2006

(54) Method for injection molding multi-layer plastic products and multi-layer plastic produts thereof

(76) Inventors: Predrag Pesovic, Beograd (YU); Vojin Pesovic, Beograd (YU)

Correspondence Address: John Russell Uren, Suite 202, 1590 Bellevue Avenue, West Vancouver, V7V 1A7, CA

(21) Appl. No.: 10/522,703

(22) PCT Filed: Jul. 28, 2003
(86) PCT No.: PCT/YU03/00020

§ 371 Date: Jan. 30, 2006

(30) Foreign Application Priority Data
Jul. 30, 2002 (YU) P-57102
Jul. 22, 2003 (YU) P-57703

(51) Int. Cl. B29C 45/16; B32B 3/10

(52) U.S. Cl. 428/137; 264/255

(57) ABSTRACT

The invention refers to the construction and the procedure for injection molding multi-layer plastic products. The procedure is to first injection mold the first layer (1) with ribbed protrusions (12). In the closed product structure, the segments (1′, 1″) of the first layer (1), with an opening (11) shaped with a solid core or in any other known way, are joined into a skeleton via inlets (13), with coupling or in any other known way. First formed layer (1) is then precisely positioned into the next mold, and over the whole, or a part of the outer surface another layer (2) is injection molded, whose opposite ribs (21) fill in the cavities between the ribs (12), and the ribs (22) now protrude out of the surface of layer (2). Layer (1) over-molded with by the layer (2) is then positioned into the next mold and the whole procedure is repeated until the desired layer (n) is injection molded whose ribs (n1) fill in the cavities or indentations of the previous layer, while on the surface of the layer (n) grooves (nu) are formed. The layer (n), which contains all the previous layers, is positioned in the last mold where the covering/finishing thin layer (p) is injection molded, whose ridges (pi) fill-in the grooves (nu) of the layer (n), while the outer surface of the layer (p), i.e. of the product, is smooth, or coarse if necessary, or profiled in a desired pattern or design.

### TECHNICAL FIELD

The invention refers to the processing and treatment of plastic mass and materials in the plastic state. It also covers multi-layer products.

According to the International Patent Classification (IPC), the invention is classified in B 29C 45/14 class, which is defined as injection molding of the inserts, B 29C 45/16, which is defined as injection molding of multi-layer or multi-colored objects, B 29 C 63/00, which is defined as over-molding of previously formed layers, B 23B 33/00, which include multi-layer products.

### TECHNICAL FIELD

This invention solves the problem of multi-layer injection molding of so the articles produced in this fashion have good mechanical properties, such as impact-resistance, scratch-resistance, resistance to breakage, good aesthetic and decorative attributes such as high surface gloss or soft to the touch, and are economic to produce, therefore this is achieved by construction and design of individual layers, constructive bond of the elements in one layer or relationship between thin and thick walls, defining procedure for injection molding so that the appropriate selection of compatible materials in successive injection molding in number of molds, by applying ribbed, grooved, indented, protruding or smooth contact surfaces among layers.

### STATE OF ART

Technical issues were described in detail in the initial patent application P-571/02. In addition, as relevant to the area, it is necessary to state the following published US patent papers:

References Cited:

U.S. Patents:
1. U.S. Pat. Nos. 3,947,177-06/09/1974—Apparatus For Injection Molding Of Multi-Layer Bodies Of Thermoplastic
2. U.S. Pat. Nos. 4,840,553-20/09/1988—Metal Mold Structure For Molding Multi-Layer Resin
3. U.S. Pat. Nos. 4,931,246-19/09/1986—Method For Injection Molding Multi-Layer Articles
4. U.S. Pat. Nos. 5,141,695-08/09/1987—Injection Molding Method For Multi-Layer Bottomed Parisons
5. U.S. Pat. Nos. 5,667,819-04/11/1994—Apparatus For Injection Molding Of Multi-Layer Objects
6. U.S. Pat. Nos. 5,851,456-28/03/1997—Method For Manufacturing A Multi-Layer Product
7. U.S. Pat. Nos. 6,129,960-10/10/2000—Methods And Apparatus For Injection Molding And Injection Blow Molding Multi-Layer Plastic And Articles Made Thereby

All the stated patents refer to apparatus and processing for simultaneous injection molding of multi-layer materials. Such a manner of molding the multi-layer materials employs extremely complex devices and molds, and complex multi-tube nozzles. Furthermore, it requires extremely complex control of viscosity, flow and temperature of materials that are being molded in various layers, which all makes the whole process even more complex, thus tending to be imprecise, ineffective and uneconomic. Some of the named processes include a combination of both injection molding and blow molding.

Generally, they all allow injection molding or blow molding of several layers of various materials, whose wall thickness is mainly uniform. In all the previously named technologies it is practically impossible to increase the cross-section (thickness of the multi-layer wall) from several times up, to several dozens times up, without compromising technical and technological requirements of the process, which are contained in: technical openings dimensions, if any, parts dimensions, aesthetics, mechanical properties, uniformity of density of material by layers, and plastic mass processing technology (processing and cooling time of injection molded layers).

### DISCLOSURE OF THE INVENTION

This invention refers to the procedure of injection molding multi-layer plastic products. According to the initial patent application P-571/02, technological procedure is defined in regards to the materials and their combinations in layers, depending on the sanitary—technical requirements in water-sanitary fixtures. The said application also refers to other technical and technological elements and finished products not in use in manufacturing process of water-sanitary products technology, but are subject to strict and precise technical and technological requirement.

This invention is completely based on the one described in P-571/02 application and implies completely the same technological processing in regard to the materials used and their combinations, however, this one defines precisely the multi-layer products designs and their manufacturing process.

According to this invention, the procedure is defined in successive injection molding of a (either thin or thick) layer upon already molded layer(s), and the first layer is injection molded in mold with a solid core, if it is part with a closed structure, or without a core, if it is a part with an open structure produced via already known methods. This procedure allows injection molding of ‘n’ layers, depending on the technical and technological requirements set for the final product.

Construction of the product itself is defined by a number of layers and their thickness, constructive bond between them (contact surface), quality (roughness) of the contact surface between the layers and construction of the first layer, depending on the requirements set for the final product. The contact surfaces between the layers, that are being injection molded one over the other, may be either smooth or rough. The surface roughness can be defined as protrusions or grooves, when thin layers are in question, or as ribbed structure, when thick layers are in question.

When closed product structures are in question, they are mostly complicated shapes, which require hermetic (sealing and water-tight) properties, so the first layer must be made in segments, which are joined in several ways and then over-molded with another layer, and in another mold.

According to this invention, advantages in construction and procedure of injection molding multi-layer plastic products are obvious in relation to the existing state of art, and were described in detail in the patent application P-571/02.

Furthermore, we should emphasize that the invention opens up unlimited possibilities in meeting the most difficult technical, technological, and sanitary requirements, where the thickness of an individual layer, or the whole product, is practically unlimited, while never compromising technical and technological requirements contained in technical openings dimensions, if any, parts dimensions, aesthetics, mechanical properties, uniformity of density of material by layers, and plastic mass processing technology (processing and cooling time of injection molded layers).

### DETAILED DESCRIPTION OF THE INVENTION

The invention is described in detail in enclosed figures:

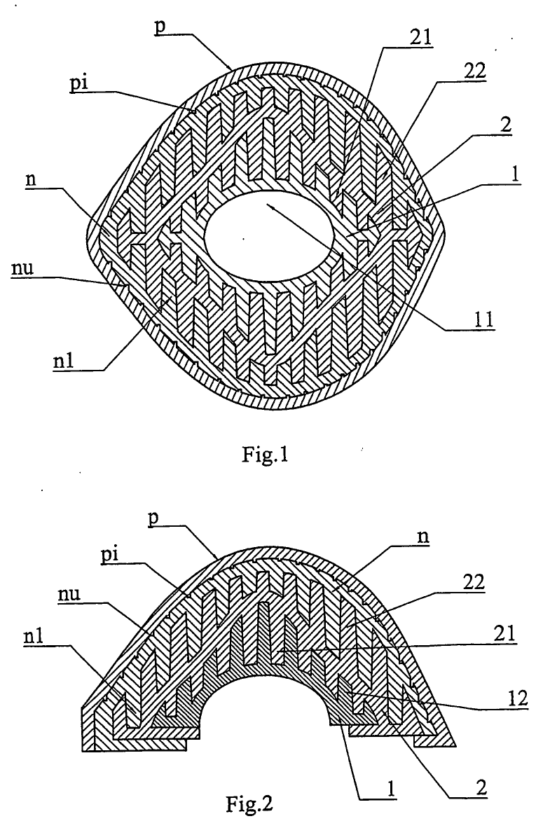

FIG. 1—dosed structure multi-layer product cross-section;

FIG. 2—open structure multi-layer product cross-section;

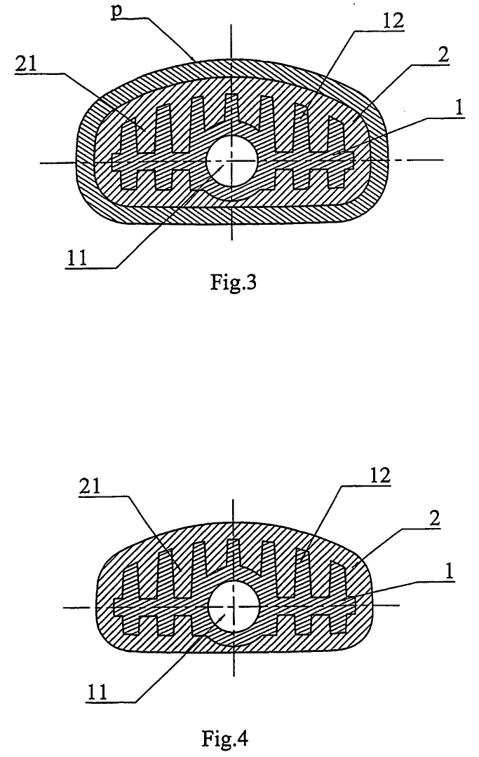

FIG. 3—three-layer product cross-section;

FIG. 4—two-layer product cross-section;

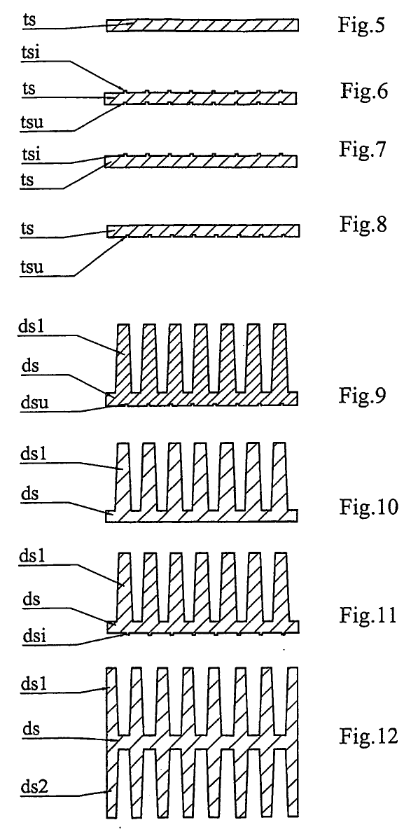

FIG. 5÷8—cross-sections of thin layers with protruding, indented and smooth surface;

FIG. 9÷12—cross-sections of thick layer with ribbed structure (grooves in between the ribs);

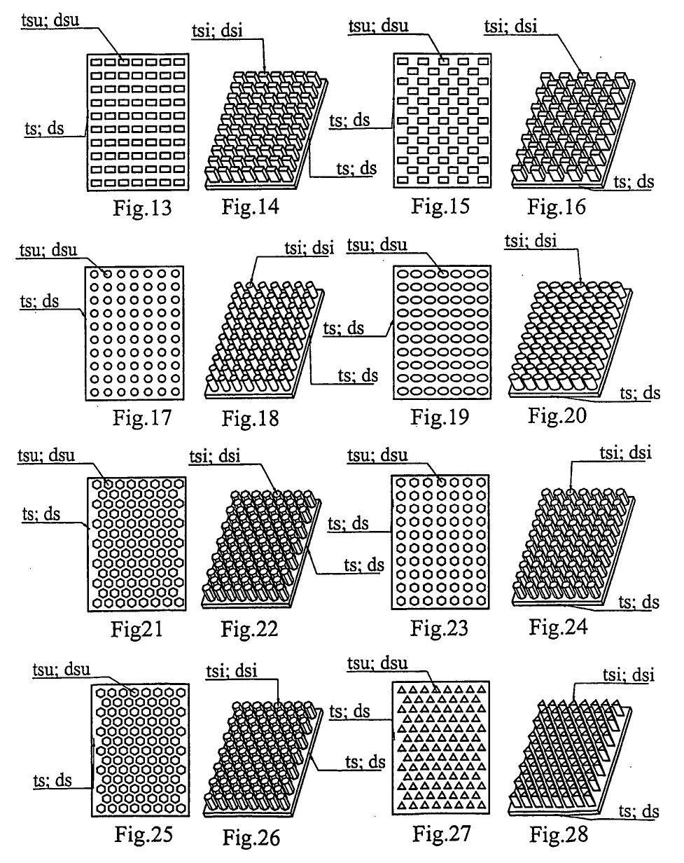

FIG. 13÷28—some of the possible shapes of protrusions and indentations in thin and thick layers and their surface positioning;

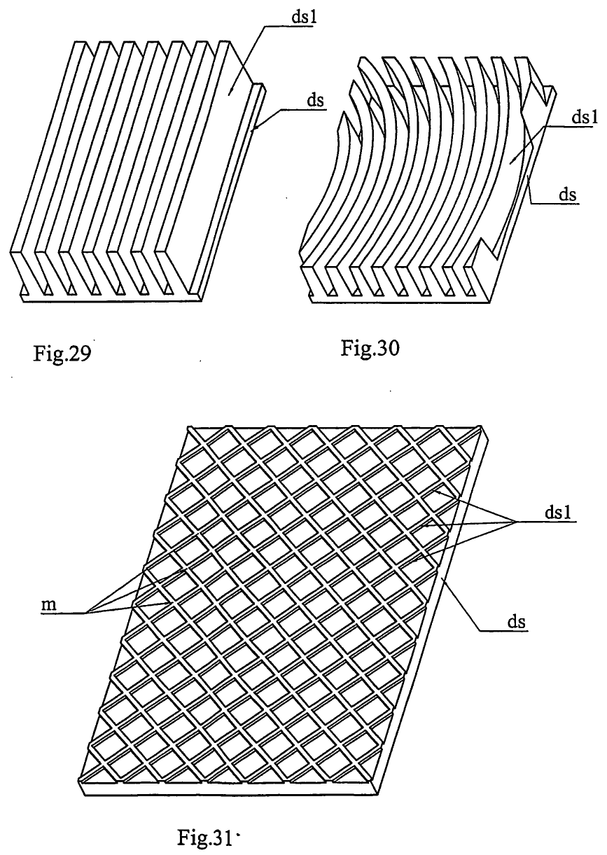

FIG. 29—ribbed structure with straight ribs;

FIG. 30—ribbed structure with circular ridges;

FIG. 31—net-like ribbed structure;

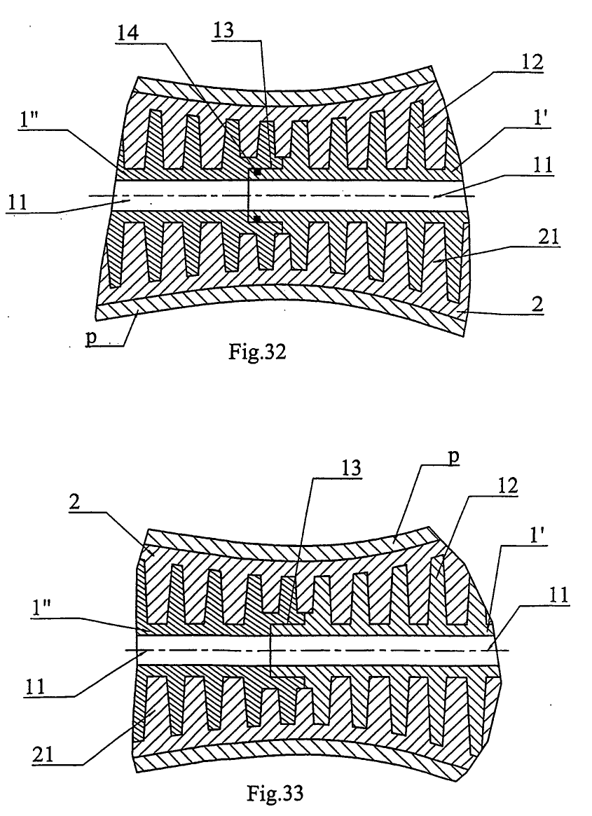

FIG. 32—cross-section of a product with the first layer elements joined with an ‘O’ ring, and

FIG. 33—cross-section of a product with the first layer elements joined without an ‘O’ ring.

The process of injection molding multi-layer plastic products is done so that the layer 1 is injection molded, actually its segments 1′, 1″, if it is the part with a closed structure (FIG. 1). On an outer surface of the layer 1, ribs 12 are formed. The opening 11 in segments 1′, 1″ is formed with a solid core in mold, or in some other way, mostly used for transporting fluids, so it is required to be made of a watertight material and that the joint of the segments 1′, 1″ is hermetically sealed. That is why they can be joined in various ways by a separable or an inseparable joint, but in any case a hermetic one. Separable joint between the segments 1′, 1″ is done along an inlet 13 where an ‘O’ ring 14 is inserted, or fastener/coupling, and the inseparable joint is also made with inlet 13 by gluing, melting, friction-welding or ultrasonic welding (FIG. 32, 33).

The layer 1 formed in this way, which makes a skeleton of a product, is very precisely positioned in the next mold and over its surface another layer 2 is injection molded, whose ribs 21 and grooves fill in the grooves between the layer 1 cavities 12. In this way a compact structure is obtained between the layers 1, 2 (FIG. 1÷4). Ribs 22 protrude from the surface of the layer 2. Layers 1, 2, now forming one compact piece, are positioned in the next mold where the layer 3 is being injection molded. The procedure is repeated several times, until the desired layer ‘n’ is injection molded which in its outer surface has either ridges ‘ni’ or grooves ‘nu’. Over the layer ‘n’, a final thin layer ‘p’ is injected, whose grooves ‘pi’ or ridges ‘pu’ fill in the ridges ‘nu’ or grooves ‘ni’ of the layer ‘n’, thus making a homogenous structure between the finishing thick layer ‘n’ and the covering thin layer ‘p’. The outer finishing layer ‘p’ may be in any color or transparent, so that the previous layer ‘n’ coloring may be seen through. Considering the surface quality, it may be smooth and shiny, or coarse or profiled in a desired pattern, depending on its purpose and defined design.

In open structure products (FIG. 2) the injection molding procedure is the same, except for the first layer which is not done in segments, but in one piece. Also, one of its surfaces may constitute the finishing one, if not coated with another layer, but not necessarily, depending on its purpose.

The layers 1-n may be made as thin layers ‘ts’ (FIG. 5÷8), or as thick layers ‘ds’ (FIG. 9÷12), or a combination of the two, whereas the covering layer is usually made thin. The thin layers ‘ts’ are approximately 0.5-6 mm, the thick layers ‘ds’ are approximately 4-30 mm.

Surfaces of the thin layers ‘ts’ may be smooth with protrusions ‘tsi’ and grooves ‘tsu’, or in any combination of the two with a smooth surface (FIG. 13÷28). The protrusions ‘tsi’ and grooves ‘tsu’ are made in a shape of a circle, square or any other geometrical figure, and upon the surface distributed in a chess-board pattern or any other geometrically symmetrical or asymmetrical position.

Surfaces with thick layers ‘ds’ may be smooth with ridges ‘dsi’ and grooves ‘dsu’ (FIG. 13÷28), or ribbed ridges ‘ds1’, ‘ds2’ (FIG. 29÷31), or in any combination of all versions with smooth surface. The ribbed ridges ‘ds1’, ‘ds2’ are of square, rectangular, triangular, trapezoid, semi-circular, or any other convenient geometrical figure. They are positioned on the layer surfaces in parallel ridges, which are straight, bent, or in a net-like pattern ‘m’, or any other surface distribution.

From the above described procedures, it is obvious that the multi-layer product manufacturing possibilities are enormous with possible combinations of shape, thickness, number of layers and types of material being virtually unlimited, while, at the same time, not leaving the scope of the invention.

1. The procedure for injection molding multi-layer plastic products, stated in full according to the initial patent application P-571/02, wherein firstly the layer (1) is injection molded with ribbed protrusions (12), and in a closed structure, the segments (1′, 1″) of the first layer (1), with an opening (11) shaped with a solid core or in any other known way, are joined into a skeleton via inlets (13) with coupling or any other known way, first shaped layer (1) formed thereby is then precisely positioned into the next mold, and over the whole, or a part of the outer surface another layer (2) is injection molded, whose opposite ribs (21) fill in the cavities between the ribs (12), and the ribs (22) now protrude out of the surface of layer (2); whereby the layer (1) is over-molded by the layer (2) and then positioned into the next mold and the whole procedure is repeated until the desired layer (n) is injection molded whose ribs (n1) fill in the cavities or indentations of the previous layer, while on the surface of the layer (n) grooves (nu) are formed; the layer (n), which includes all the previous ones, is positioned in the last mold where the covering, finishing thin layer (p) is injection molded, whose ridges (pi) fill-in the grooves (nu) of the layer (n), while the outer surface of the layer (p), i.e. of the product, is smooth, or coarse if necessary, or profiled in a desired pattern or design.

2. The injection molding procedure for the multi-layer plastic products of open structure, according to the claim 1 wherein the first layer (1) with its ribbed protrusions (12) is over-molded by the layer (2), and the procedure is repeated until the desired layers (n), or the covering/finishing layer (p) is completed where the (1÷n) layers are made as thin layers (ts), or as thick layers (ds) and are dictated by the technical requirements and technological requirements and characteristics, whereas the covering/finishing layer (p) is molded according to the aesthetical requirements.

3. Multi-layer plastic product design, according to the claims 1, 2 wherein the top surface and bottom surface of the thin layers (ts) are molded as smooth or with protrusions (tsi) or with grooves (tsu), and/or in any combination of the stated protrusions and grooved surfaces.

4. Multi-layer plastic product design according to the claims 1÷3 wherein the top surface and bottom surface of the thick layer (ds) are molded smooth or with protrusions (dsi) or with grooves (dsu), with ribs (ds1, ds2), or in any of the combinations of the aforementioned.

5. Multi-layer plastic product design according to the claim 4 wherein the protrusions or ribs (tsi, dsi) and indentations or grooves (tsu, dsu) made in the shape of a circle, square or any other geometrical figure are distributed in a chess board pattern, diagonally or in any other shape, form or fashion.

6. Multi-layer plastic product design according to the claim 5 wherein the ribbed protrusions (ds1, ds2) are the cross-sections of the square, rectangle or any other geometrical figure distributed upon the surfaces of the layers (1÷n) in the shape of straight parallel ribs, arbitrarily shaped, or criss-crossed in a net-like pattern (m) or any other surface distribution.

7. Multi-layer plastic product design according to the claim 1 wherein the segments (1′, 1″) of the first layer (1) are joined in a separable manner along the inlet (13) where an ‘O’ ring is inserted (14), or with coupling, or in an inseparable manner, by gluing, melting, friction-welding or ultrasonic welding in the inlet (13) joining point.
